(19) United States
(12) Patent Application Publication
(10) Pub. No.: US 2007/0076363 A1
(43) Pub. Date: Apr. 5, 2007

(54) NOTEBOOK COMPUTER WITH DETACHABLE DISPLAY AND SUPPORT STAND FOR DETACHABLE DISPLAY

(76) Inventors: Wei-Kuang Liang, Shenzhen (CN); Gang-Hua Liu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,137

(22) Filed: Jun. 27, 2006

(30) Foreign Application Priority Data
Jul. 15, 2005 (CN) 200510036033.2

(51) Int. Cl. G06F 1/16

(52) U.S. Cl. 361/683; 361/681

(57) ABSTRACT

A notebook computer and an associated support stand are provided. The notebook computer includes a main body, a detachable display, and a hinge assembly. The support stand defines a hinge assembly thereof. The hinge assembly includes two hinges, two guiding portions, and an electrical connector. The hinges are fixed on the main body or the support stand. The guiding portions are connected with the hinges. The detachable display defines two openings for receiving the two guiding portions, and includes an electrical connector for detachable connecting with the electrical connector of the hinge assembly. The detachable display has locking mechanisms, which can fix the position of the display after it has been attached to the main body or the support stand. Employing the above-mentioned structure, the detachable display can be easily detached from the main body of the notebook computer and conveniently used as a desktop with the support stand.

### FIELD OF THE INVENTION

The present invention relates to notebook computers and associated displays; and particularly to a notebook computer having a structure for allowing attachment and detachment of a detachable display to and from a main body of the notebook computer, and to a support stand for a similarly attachable/detachable display.

### DESCRIPTION OF RELATED ART

Computers are in widespread use, and notebook computers in particular are getting more and more popular because of their portability. Typically, a liquid crystal display (LCD) unit of a notebook computer is rotatably fixed to a main body of the notebook computer, however recent developments have seen the introduction of notebook computers with detachable LCD units.

For example, China patent No. 97222337.1 shows this kind of notebook computer. The detachable display has two slots to cooperate with two posts based on the main body or on a commutator, and the connection of the slots and the posts is locked by two levers. However, if the levers fail the connection will fail too. Additionally, when the LCD is fixed on the commutator, the height of the LCD cannot be adjusted. Therefore what is needed is a notebook computer with a conveniently detachable display and a support stand that allows positional adjustment of the display.

### SUMMARY OF THE INVENTION

A notebook computer with a detachable display is provided. The notebook computer includes a main body, a hinge assembly, and a detachable display. The main body defines a recess. The hinge assembly is at least partially received in the recess and includes an electrical connector, two guiding portions, and two hinges. The two guiding portions are combined with the two hinges respectively. The two hinges are attached on the main body. The detachable display includes an electrical connector, two openings, and two locking mechanisms. The two locking mechanisms are slidable between a locked state and an unlocked state. The openings are for receiving the guiding portions. The electrical connector of the hinge assembly and the electrical connector of the detachable display are detachably connectable with each other. The detachable display is movably locked onto the main body when the locking mechanisms are in the locked state. The detachable display is removable from the main body when the locking mechanisms are in the unlocked state.

A support stand for a notebook computer's detachable display is also provided. The support stand includes an upper board, a bottom board, a support hinge, and a hinge assembly. The support hinge connects the upper board to the bottom board. The hinge assembly is positioned on an upper end of the upper board and includes two hinges, two guiding portions, and an electrical connector. The hinges are respectively fixed on the upper board. The guiding portions are respectively rotatably fixed on the two hinges and are configured for removable insertion into openings of the detachable display. The electrical connector is configured for detachable connection to a corresponding electrical connector of the detachable display.

Further features will be described or will become apparent in the course of the following detailed description when read in conjunction with the attached drawings, in which:

### BRIEF DESCRIPTION OF DRAWINGS

FIG. 1 is a schematic, isometric view of a notebook computer according to a first embodiment of the present invention, the notebook computer including a detachable display, a main body, and a hinge assembly;

FIG. 2 is an exploded view of the hinge assembly and part of the main body of FIG. 1, not showing an upper cover of the main body;

FIG. 3 is a schematic, isometric view of the hinge assembly and part of the main body of FIG. 1, not showing a hinge cover of the hinge assembly and not showing the upper cover of the main body;

FIG. 4 is an exploded view of the detachable display of FIG. 1;

FIG. 5 is a schematic, isometric view of a detachable display combined with a support stand according to a second embodiment of the present invention;

FIG. 6 is an exploded view of the support stand of FIG. 5;

FIG. 7 is a back view of the detachable display combined with the support stand of FIG. 5; and

FIG. 8 is a left side plan view of the detachable display combined with the support stand of FIG. 5.

### DETAILED DESCRIPTION

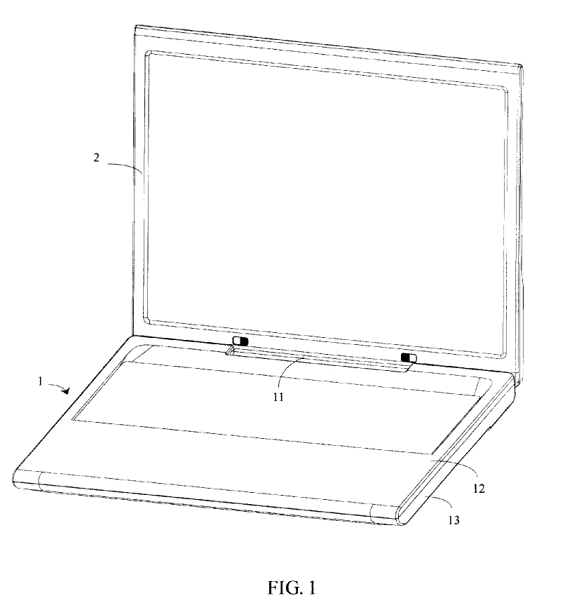

Referring to FIG. 1, a notebook computer with a detachable display in accordance with a first embodiment of the present invention is shown. The notebook computer includes a main body 1, the detachable display 2, and a hinge assembly 11. The main body 1 includes a top 12 and a bottom 13.

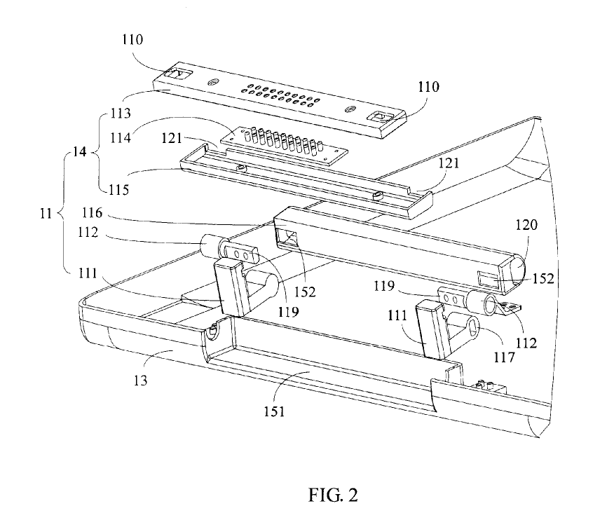

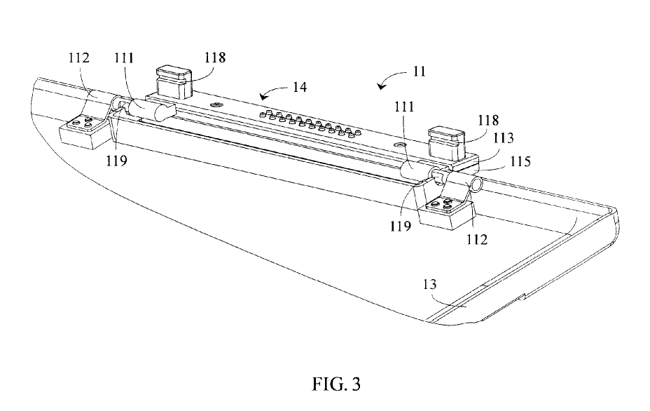

Referring to FIGS. 2 and 3, the hinge assembly 11 is received in a recess 151 of the main body 1, and includes an electrical junction 14, two guiding portions 111, two hinges 112, and a hinge cover 116. The electrical junction 14 includes an upper cover 113, an electrical connector 114, and a lower cover 115. The upper cover 113 and the lower cover 115 cooperate to form a quadrate vessel for receiving the electrical connector 114 and the two guiding portions 111. The lower cover 115 defines an opening (not shown) therein so that cables can pass through the lower cover 115 to connect with the electrical connector 114. The upper cover 113 defines openings 110 therein for upright parts of the guiding portions 11 to pass therethrough. Moreover, the upper cover 113 and the lower cover 115 respectively define openings 121 in adjoining sidewalls thereof. The openings 121 cooperate to respectively receive the guiding portions 11 therein. The guiding portions 11 are substantially L-shaped. Each guiding portion 11 has a shaft section 117 defined at one end thereof, and a groove 118 defined in another end thereof. The hinge cover 116 defines two openings 152 therein, the openings 152 receiving the shaft sections 117 of the guiding portions 11 therethrough during assembly. The hinges 112 are attached on the bottom 13 by bolts. Each hinge 112 includes a pivot 119. The pivots 119 pass through two opposite openings 120 of the hinge cover 116 and plug into the shaft sections 117 respectively.

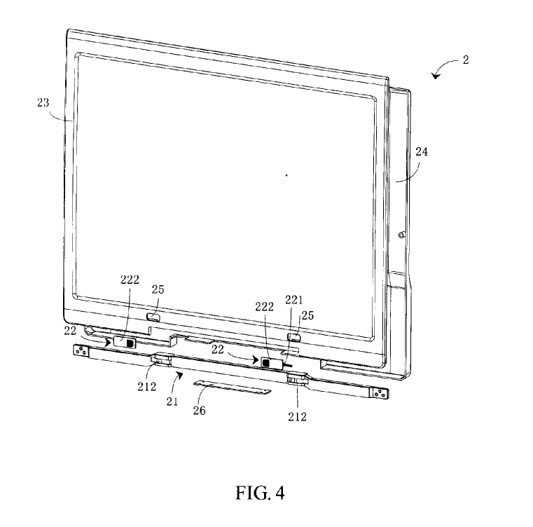

Referring to FIG. 4, the detachable display 2 includes a front cover 23, a back cover 24, a framework 21, an electrical connector 26, and two locking mechanisms 22. The framework 21 is assembled at a bottom of the detachable display 2 between the front cover 23 and the back cover 24. Further, the framework 21 defines two openings 212 which correspond to the guiding portions 111. The electrical connector 26 is placed in an appropriate position in the bottom of the detachable display 2 and corresponds to the electrical connector 114. Each locking mechanism 22 includes a locking key 222 and a spring 221. The locking keys 222 of the locking mechanisms 22 are connected to the front cover 23 through the springs 221, and can be moved in two openings 25 of the front cover 23 to provide particular functions. For example, when the two locking keys 222 are moved towards each other in the openings 25, the two springs 221 are moved to normal positions, and the locking mechanisms 22 enter into a locked state in which the detachable display 2 and the main body 1 are locked together. In contrast, when the two locking keys 222 are moved away from each other in the openings 25, the two springs 221 are elongated, and the two locking mechanisms 22 enter into an unlocked state in which the detachable display 2 can be detached from the main body 1.

In assembling the detachable display 2 on the main body 1, firstly the locking keys 222 in the openings 25 are manually moved away from each other. Thereby, the springs 221 are compressed. Next the detachable display 2 is lowered onto the hinge assembly 11, so that the guiding portions 111 are inserted into the openings 212 and the electrical connector 114 of the hinge assembly 11 connects with the electrical connector 26 of the detachable display 2. Then the locking keys 222 are released. The springs 221 rebound and urge the locking keys 222 toward each other, thus causing ridge parts (not shown) of the locking keys 222 to engage in grooves 118 of the guiding portions 111. Thereby, the detachable display 2 is rotatably connected to the main body 1, so that the detachable display 2 can be opened and closed relative to the main body 1. Conversely, if the user wants to separate the detachable display 2 from the main body 1, he or she can move the locking keys 222 in the openings 25 away from each other, disconnect components connected between the detachable display 2 and the main body 1, and then pull the detachable display 2 away from the main body 1.

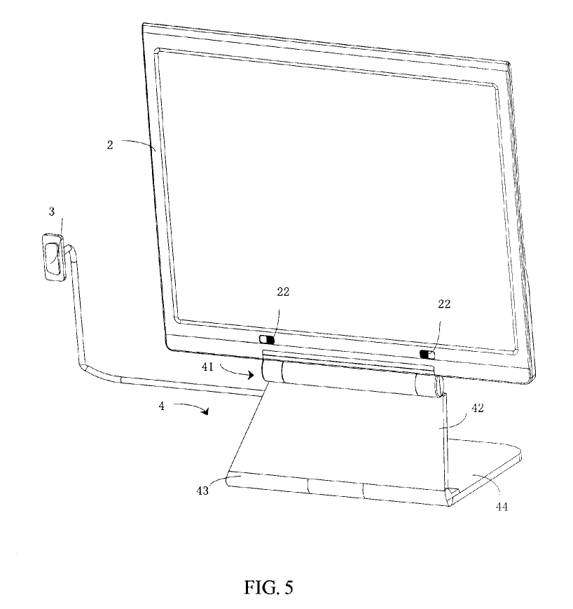

Referring to FIG. 5, this is a schematic, isometric view of a detachable display combined with a support stand according to a second embodiment of the present invention. The detachable display 2 can be rotatably attached on a support stand 4 and connected to a main body of an electrical apparatus by a cable 3. The detachable display 2 can then be used as a display of the electrical apparatus. The electrical apparatus can for example be a notebook computer, a desktop computer, and so on.

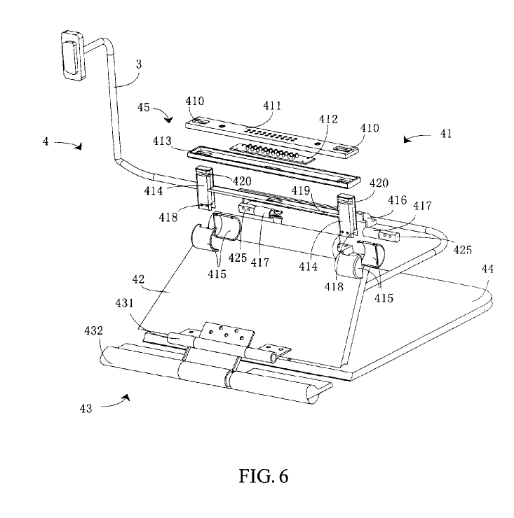

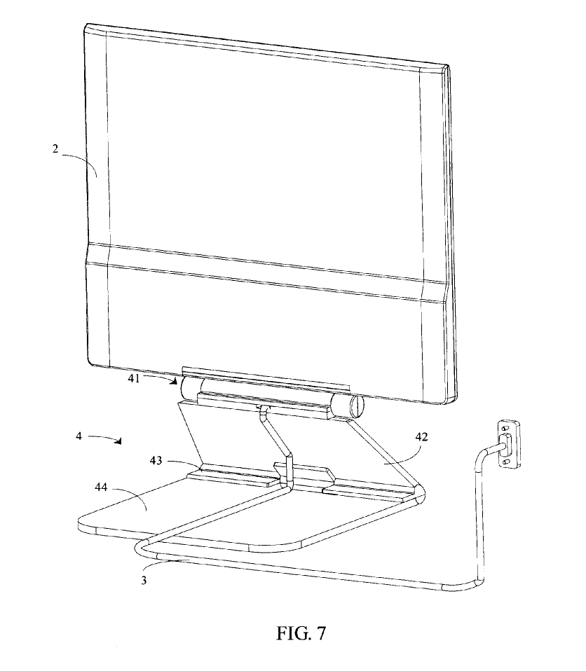

Referring to FIGS. 6 and 7, the support stand 4 includes a hinge assembly 41, an upper board 42, a support hinge 43, and a bottom board 44. The support hinge 43 connects the upper board 42 and the bottom board 44 with each other. The support hinge 43 includes a hinge 431 and a hinge cover 432. The hinge cover 432 covers the hinge 431. The hinge assembly 41 is positioned on an upper end of the upper board 42. The hinge assembly 41 includes an electrical junction 45, two guiding portions 414, two hinges 417, a hinge cover 416, and four sheaths 415. The hinges 417 are combined with the upper board 42. Each hinge includes a pivot 425. The pivots 425 are plugged into grooves 418 of the guiding portions 414. The guiding portions 414 connect with each other through a rail 419. The electrical junction 45 includes an upper cover 411, an electrical connector 412, and a lower cover 413. The upper cover 411 and the lower cover 413 cooperate to form a quadrate vessel to receive the electrical connector 412, the guiding portions 414, and the rail 419. The lower cover 413 defines an opening (not shown) therein so that cables can pass through the lower cover 413 to connect with the electrical connector 412. Further, the upper cover 411 and the lower cover 413 respectively define openings 410 in ends thereof. By way of the openings 410, the guiding portions 414 pass through the upper cover 411 and the lower cover 413. The hinge cover 416 and an upper end of the upper board 42 form a cylinder. The sheaths 415 cover parts of the guiding portions 414 and the hinges 417 that respectively interconnect with each other.

In assembling the detachable display 2 on the support stand 4, firstly the locking keys 222 in the openings 25 are manually moved away from each other. Thereby, the springs 221 are compressed. Next the detachable display 2 is lowered onto the hinge assembly 41, so that the guiding portions 414 are inserted into the openings 212 and the electrical connector 412 of the hinge assembly 41 connects with the electrical connector 26 of the detachable display 2. Then the locking keys 222 are released. The springs 221 rebound and urge the locking keys 222 toward each other, thus causing ridge parts (not shown) of the locking keys 222 to engage in grooves 420 of the guiding portions 414. Thereby, the detachable display 2 is rotatably connected to the support stand 4. Conversely, if the user wants to separate the detachable display 2 from the support stand 4, he or she can move the locking keys 222 in the openings 25 away from each other, disconnect components connected between the detachable display 2 and the support stand 4, and then take the detachable display 2 away from the support stand 4.

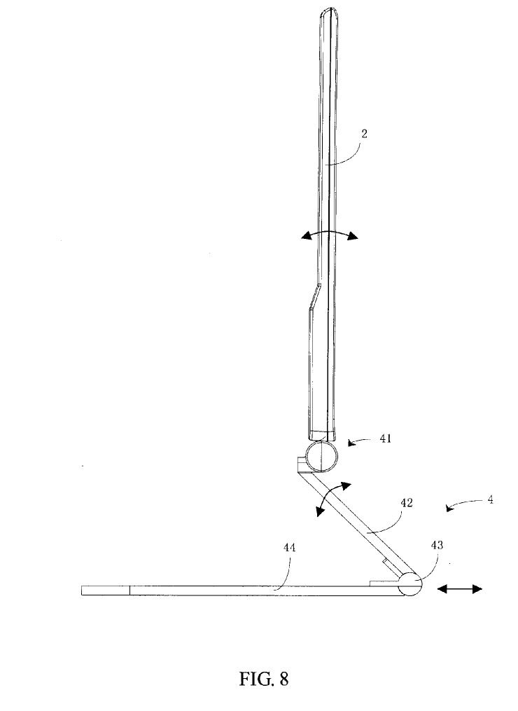

Referring to FIG. 8, a user can rotate the detachable display 2, rotate the upper board 42, and horizontally move the support stand 4 along the respective directions indicated by the double-headed arrows in order to adjust the position and/or the angle of the detachable display 2.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A notebook computer with a detachable display, the notebook computer comprising:
a main body comprising a recess;
a hinge assembly at least partially received in the recess, wherein the hinge assembly comprises an electrical connector, two guiding portions, and two hinges, the two guiding portions are combined with the two hinges respectively, and the two hinges are attached on the main body; and
a detachable display comprising:
an electrical connector;
two openings; and
two locking mechanisms, which are slidable between a locked state and an unlocked state;
wherein the openings are for receiving the guiding portions, and the electrical connector of the hinge assembly and the electrical connector of the detachable display are detachably connectable with each other; and
the detachable display is movably locked onto the main body when the locking mechanisms are in the locked state, and the detachable display is removable from the main body when the locking mechanisms are in the unlocked state.

2. The notebook computer of claim 1, wherein each of the locking mechanisms comprises a locking key and a spring, the spring movably connecting the locking key to the detachable display.

3. The notebook computer of claim 2, wherein each of the guiding portions comprises a groove, the grooves engagingly receiving portions of the locking keys when the locking mechanisms are in the locked state.

4. A support stand for a detachable display, the support stand comprising:
an upper board and a bottom board;
a support hinge connecting the upper board to the bottom board; and
a hinge assembly positioned on an upper end of the upper board, wherein the hinge assembly comprises two hinges, two guiding portions, and an electrical connector, said two hinges are respectively fixed on the upper board, and the guiding portions are respectively rotatably fixed on said two hinges;
wherein the guiding portions are configured for removable insertion into openings of the detachable display, and the electrical connector is configured for detachable connection to a corresponding electrical connector of the detachable display.

5. The support stand of claim 4, wherein each of the guiding portions comprises a groove configured for disengagably receiving a corresponding locking portion of the detachable display.
